(19) United States
(12) Patent Application Publication
(10) Pub. No.: US 2010/0010776 A1
(43) Pub. Date: Jan. 14, 2010

(54) PROBABILISTIC MODELING OF COLLABORATIVE MONITORING OF POLICY VIOLATIONS

(76) Inventors: Indranil Saha, Kolkata (IN); Janardan Misra, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(21) Appl. No.: 12/171,225

(22) Filed: Jul. 10, 2008

(51) Int. Cl. G06F 17/18

(52) U.S. Cl. 702/181

(57) ABSTRACT

A payoff matrix based collaborative monitoring model presents a formal framework for defining policies to assign different payoffs for different subjects corresponding to their reporting behavior against different policy violations. An embodiment such as a formal model can be used by security administrators to get better estimates on various factors affecting the required parameters controlling the payoff values, e.g., reporting behavior of users, group dynamics, characteristics of the violations, and likelihood of detection. The proposed model effectively complements the payoff matrix-based approach for enabling the collaborative monitoring of policy violations.

### TECHNICAL FIELD

Various embodiments relate to the monitoring of policy violations, and in an embodiment, but not by way of limitation, probabilistic modeling of collaborative monitoring of policy violations.

### BACKGROUND

With the increasing size of today's organizations and their dynamically changing asset bases, designing appropriate security policies and the enforcement of these policies to maintain confidentiality and integrity of these assets is becoming increasingly difficult. One of the noticeable limitations of existing security frameworks is the separation of responsibilities, whereby a user base of assets is differentiated from the system administrators who design and enforce these policies.

### BRIEF DESCRIPTION OF THE DRAWINGS

FIG. 1 illustrates a state transition diagram for an environment module.

FIG. 2 illustrates a state transition diagram for a subject detecting only primary violations.

FIG. 3 illustrates a state transition diagram for a subject detecting primary and secondary violations.

FIG. 4 is a graph illustrating a variation of reporting probabilities with changes in the number of subjects.

FIG. 5 is a graph illustrating a variation of reporting probabilities with changes in the detection probability and motivation index.

FIG. 6 is a block diagram of a processor-based architecture upon which one or more embodiments of the present disclosure can operate.

FIG. 7 illustrates an example embodiment of a payoff matrix.

FIG. 8 is a flowchart of an example embodiment of a process to monitor dynamic behavior in a collaborative monitoring system.

### DETAILED DESCRIPTION

In the following detailed description, reference is made to the accompanying drawings that show, by way of illustration, specific embodiments in which the invention may be practiced. These embodiments are described in sufficient detail to enable those skilled in the art to practice the invention. It is to be understood that the various embodiments of the invention, although different, are not necessarily mutually exclusive. Furthermore, a particular feature, structure, or characteristic described herein in connection with one embodiment may be implemented within other embodiments without departing from the scope of the invention. In addition, it is to be understood that the location or arrangement of individual elements within each disclosed embodiment may be modified without departing from the scope of the invention. The following detailed description is, therefore, not to be taken in a limiting sense, and the scope of the present invention is defined only by the appended claims, appropriately interpreted, along with the full range of equivalents to which the claims are entitled. In the drawings, like numerals refer to the same or similar functionality throughout the several views.

Embodiments of the invention include features, methods or processes embodied within machine-executable instructions provided by a machine-readable medium, such as an in electronic control unit (ECU). A machine-readable medium includes any mechanism which provides (i.e., stores and/or transmits) information in a form accessible by a machine (e.g., a computer, a network device, manufacturing tool, any device with a set of one or more processors, etc.). In an exemplary embodiment, a machine-readable medium includes volatile and/or non-volatile media (e.g., read only memory (ROM), random access memory (RAM), magnetic disk storage media, optical storage media, flash memory devices, etc.), as well as electrical, optical, acoustical or other form of propagated signals (e.g., carrier waves, infrared signals, digital signals, etc.)).

Such instructions are utilized to cause a general or special purpose processor, programmed with the instructions, to perform methods or processes of the embodiments of the invention. Alternatively, the features or operations of embodiments of the invention are performed by specific hardware components which contain hard-wired logic for performing the operations, or by any combination of programmed data processing components and specific hardware components. Embodiments of the invention include digital/analog signal processing systems, software, data processing hardware, data processing system-implemented methods, and various processing operations, further described herein. As used herein, the term processor means one or more processors, and one or more particular processors can be embodied on one or more processors.

One or more figures show block diagrams of systems and apparatus of embodiments of the invention. One or more figures show flow diagrams illustrating systems and apparatus for such embodiments. The operations of the one or more flow diagrams will be described with references to the systems/apparatuses shown in the one or more block diagrams. However, it should be understood that the operations of the one or more flow diagrams could be performed by embodiments of systems and apparatus other than those discussed with reference to the one or more block diagrams, and embodiments discussed with reference to the systems/apparatus could perform operations different than those discussed with reference to the one or more flow diagrams.

A collaborative monitoring-based approach treats collective responsibility of users of a system to secure assets from access violations. For example, a malicious user passing on the sensitive intellectual property (IP) related information to an unauthorized source could be better monitored and reported for doing so by associated team members, who probably have a better knowledge of such malicious passing or can better detect it than centrally administered monitoring mechanisms.

Thus, to make users responsible for the security of assets, a collaborative monitoring approach involves everyone in the organization in different aspects of security including threat perception, monitoring, and reporting of the violation of policies regarding the usage of the assets.

The payoff matrix based model defined below stipulates various payoffs as reward, punishment, and community price according to the reporting of genuine or false violations, non-reporting of the detected violations, unreported violations, and proactive reporting of potential violations by users. As a consequence, effectiveness of that model critically depends on the appropriate assessment and estimation for the various parameters, e.g., individual rewards, punishments, and community price. These assessments are generally carried out by security administrator(s) depending on their experience and organizational context. Often these assessments remain imprecise and may adversely affect the success of the model.

There is therefore a need to formulate a formal model which can be used by security administrators to get better estimates on various factors affecting the required parameters, e.g., reporting behavior of users, group dynamics, characteristics of the violations, and the likelihood of the detection. An embodiment fills this gap by proposing a formal mathematical model and corresponding parameter estimation techniques.

A payoff matrix based collaborative monitoring model is described in U.S. patent application Ser. No. 12/057,855 filed Mar. 28, 2008, and which is hereby incorporated by reference. It presents a formal framework for defining policies to assign different payoffs for different subjects corresponding to their reporting behavior against different policy violations.

More specifically, the payoff matrix uses underlying assumptions such as the following.

Observability: Proposed model assumes that all genuine occurrences of violations of access restrictions have an impact on the system, which will always be observable (albeit might be later on with some delay). Thus, only such violations are considered that affect the state of the system and other kinds of “passive” violations not affecting the system are not discussed as far as the observable security of the system is concerned. This implies that the truth and falsity of any genuine occurrence of violations will always be verifiable.

Detectability: A violation is deemed to be detectable/detected only when it is reported to be done so (either by subjects/users or some monitoring device). Therefore if a violation occurs but is not reported by any of the witnesses (or captured by the monitoring device), it would be deemed undetected. Detection of a violation is thus temporally restricted and is different from the observable impact of it. A detectable violation would possibly enable inferring possible causal factors of it and might reduce the impact of the violation by enabling early curative measures.

Non-Reporting Violation: Another important assumption of the model is that non-reporting of an access restriction violation is a violation in itself and must invite punishment. It is assumed that in the absence of such treatment it might not be possible to give rise to a dynamically evolving and increasingly secure system with collective responsibility.

Policy Synthesis: The model assumes that access restrictions on the objects (e.g., physical and logical resources) are defined a priory. Indeed, devising access restrictions on objects is orthogonal to the monitoring process considered here. Nonetheless, it is possible that as a by product of the monitoring process, access restrictions, which have not been listed yet, can potentially be integrated into the framework. One such case might arise when certain sequence of accesses enable other access restriction violations so reporting the final access violation in terms of the scenarios consisting of the sequence of events (each event is an operation on an object by some subject) might give rise to new set of access restrictions. In this disclosure, the term “subject” is meant to denote users of the resources (physical and logical) or the processes running on behalf of the users.

Authentication: The members of community are assumed to be duly authenticated in order to determine whether resources are being legitimately accessed or not. Indeed, the very identification of an access restriction violation depends on the authentication of the subjects as well as assets.

Quantifiable: The effect of an access violation should be quantified so that rewards and punishments can be appropriately defined in a consistent manner.

Model Execution: The model assumes that there exists some execution framework which could calculate the payoff matrices and enforce the rewards and punishments for the members as conceptualized in the model. Indeed, in the absence of such a mechanism, collaborative monitoring could hardly be deemed effective.

Knowledge completeness: The model assumes that members have knowledge of legitimate accesses and capability to detect and report genuine violations.

Certain socio-psychological aspects of behavior illustrate underlying reasons of the design of the model. There are numerous studies on the role of extrinsic motivation in individual and group behavior. Organizations usually face this question of how to keep its employees and teams sufficiently motivated through external rewards and policies.

The model is derived from knowledge and insights into usual behavioral effects of various kinds of rewards and punishments. Extrinsic rewards are usually important motivators to start new behaviors in the individuals. Group punishment mechanisms usually play an important role in the continuation of the intuitively justified community behaviors. Individuals in groups tend to exert pressures on other individuals to avoid themselves from paying community punishments owing to the violations caused by others.

Apart from rewards, punishments are also used as negative reinforcement tools for the individuals, who try to avoid such punishments by following the expected behaviors. Nonetheless, unless expected behaviors have been internalized by the individuals, the withdrawal of such negative reinforcements may put individuals at the risk of reverting back to the old situation.

On the other hand, group rewards usually do not produce much impact on the individual behaviors as people usually expect something unique for themselves in the rewards, which usually remains implicit with group rewards. Based upon the above, a payoff matrix model can serve as an enabling mechanism for the collaborative monitoring.

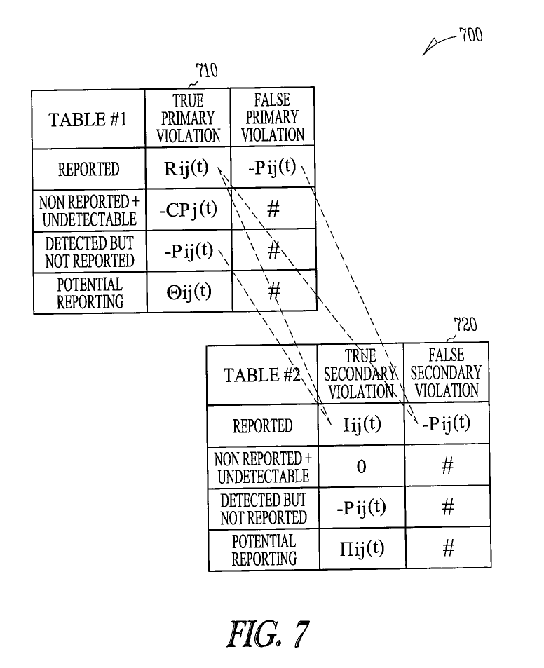

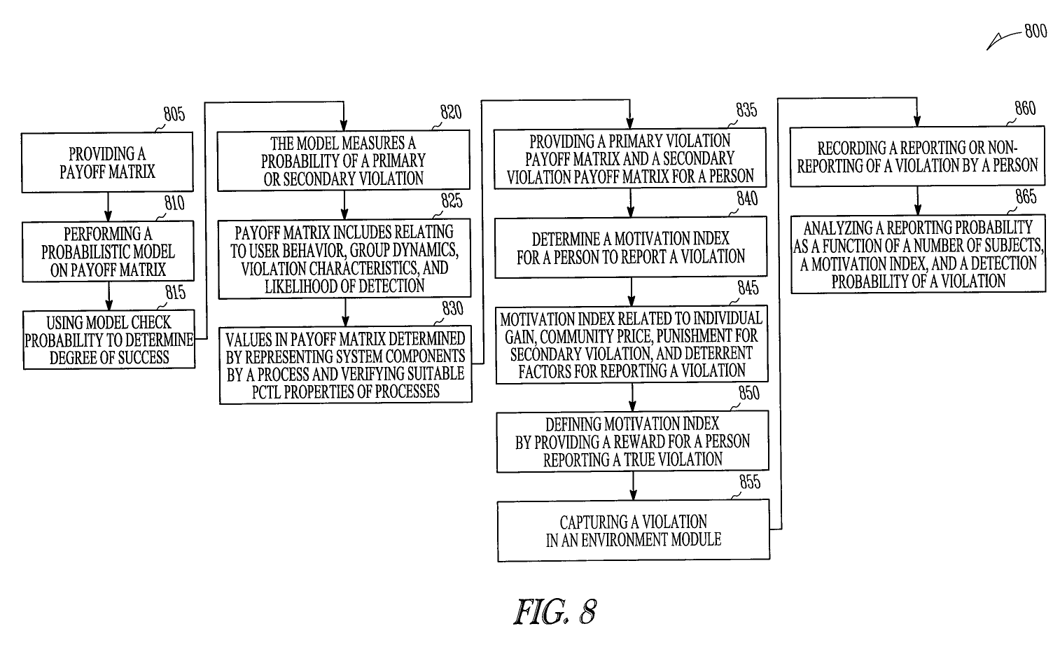

A data structure, referred to as a pay off matrix in one embodiment, for determining suitable reward/punishments on security violations reported by a user is illustrated in FIG. 7 generally at 700. The data structure 700 allows information to be obtained and processed to reward and optionally punish behaviors by users in an effort to encourage collaboration of users (subjects) in the protection of assets and compliance and improvement of asset protection systems. In one embodiment, the data structure comprises a first table 710 and a second table 720. Each table contains data for different behaviors associated with real and potential policy violations. Table 710 has two columns having four rows of cells each containing time varying information regarding true primary violations and false primary violations. The rows categorize the reporting behavior of the persons. The types of reporting in the rows comprises reported, not reported and undetectable, detected by but not reported, and potential reporting. Table 720 has columns for true secondary violation and false secondary violation, with the same rows.

Associated with each person or subject, two types of time varying payoff matrices for the set of policy violations on the objects on which the subject has due access rights, as depicted in table 710 and table 720. The first pay-off matrix, table 710, defines the pay-offs associated with an i^{th} person (or subject) Sᵢ for a j^{th} object Oⱼ on its reporting behavior for an access restriction violation. It is possible that different access restrictions on the same objects would give rise to different violations (e.g., sharing a file with a peer inside the same organization might invite less punishment than sharing it with the external contacts) and thus each entry in the tables can be considered as a function of access restriction rules themselves. In general, any security policy can be considered to define these payoff matrices where access restrictions policies are one such example.

The second pay-off matrix, table 720, defines the pay-offs associated with the i^{th} person Sᵢ for the j^{th} object Oⱼ on its reporting behavior for non reporting of an access restriction violation by some other person (e.g., see the assumption of Non-Reporting Violation as discussed above).

In table 710, the first column—True Primary Violation—represents the case when an actual violation of access restrictions for Oⱼ has indeed occurred—the impact of which is assumed to be observable later on. The second column—False Primary Violation—represents the false violations where the person Sᵢ may act on the basis of a fabricated violation—a violation impact of which would never be observed. Such false violations might well be based on unreliable or unverified information sources, such as rumors. Reporting of these violations must invite punishment since they might be aimed towards falsely implicating others and are based upon non verifiable claims.

Rows categorize the reporting behavior of the persons. Cases of reporting of violations after they have occurred and of potential violations reported in advance are considered, which might occur if suitable measures on implementing the access restrictions are not kept in place. The first three rows describe the first situation and the last row describes the later case where a possible violation is reported in advance.

When a violation occurs, either Sᵢ would report such a violation (by detecting it) [Row 1] or it will go unreported. The case of non-reporting is further classified into two categories: i) Row 2 represents the scenario where Sᵢ did not report it and the possible violation was undetectable (that is, no one else also reported it.) ii) Row 3 represents the scenario where Sᵢ detected a violation but did not report it, while some other person detected as well as reported it. To establish such a case, another pay-off matrix as depicted in table 720 must be considered, wherein the detection and reporting of such non reporting instances, which are necessary to make such reporting possible, are mandatory. The last row is meant to capture a potential violation, which is supposedly possible under given security policy specifications.

In table 720, the first column—True Secondary Violation—represents that case, where the person Sᵢ detects a violation and also detects some other person(s) detecting the same violation though not reporting it. On the other hand, the second column in table 720—False Secondary Violation—represents that scenario, where the person Sᵢ may act on the basis of a false or fabricated scenario and blame that such a scenario was witnessed by some other persons but they did not report it.

Each payoff entry in the tables is now discussed.

Notation: Table#N:CELL[i,j] denotes the cell in i^{th} row and j^{th} column in Table#N, where row/column indexing starts from 1.

All the entries in the table are functions of time, thereby implying that their actual value at any time might be dependent upon the previous events or past behaviors of the persons. The variable t represents the time variable with granularity of reporting occurrences.

Table#1:CELL[1,1]: The first cell in the table represents the scenario where person Sᵢ detects a violation and duly reports it and is rewarded with Rᵢⱼ(t). Any community based collaborative monitoring process can be made effective only when such reporting is associated with the due incentives at least to partly balance the reporting overhead, though, the actual value of the reward itself can be based upon the characteristics of the object Oⱼ and the nature of access violation and can very well vary over time. Indeed, the reward can also depend upon the time delay between the actual occurrence of the violation and the time when it is reported. An increase in the trust levels or clearance levels for subjects as defined in various mandatory access control models can be considered as an example for such a reward.

In order to avoid false reporting of a true violation, in a case where a majority of the persons who detected and reported the violation also report that a certain person did not actually detect the violation, but only reported the violation only to get a share in the reward, that person's reward should be withdrawn, and that person's reward should be distributed appropriately among all the reporting persons.

Table#1:CELL[1,2]: The 2^{nd} cell in the 1^{st} row represents the scenario where the person Sᵢ reports a false violation (self imagined violation to falsely implicate other users) that needs to be punished with −Pᵢⱼ(t). Again, an actual value of such punishment itself can be based upon the characteristics of the object Oⱼ and the reported nature of the access violation as well as the past behavior of the person Sᵢ. That is, in case Sᵢ is found to be repeatedly falsely implicating others, associated punishments should increase correspondingly. This can be formalized by defining Pᵢⱼ(t)=Pᵢⱼ(t−1)+c, where c is some positive constant. Notice that it is assumed that every genuine violation has some observable impact hence falsity of any such reported violation is verifiable (see the assumption of Observability defined above).

Table#1:CELL[2,1]: The 1^{st} cell in the 2^{nd} row represents the scenario where a violation occurs but it is not reported to be detected by any person. In such a case, each person pays a community price for it as denoted by −CPⱼ(t). Consider for example a sensitive source code is being copied and transferred by some of the members of the project team and none of those who had knowledge of it reported it. Since its impact would be anyway felt at some stage later, all the associated team members need to bear some loss for this.

Such a community price to be paid by each associated member can be a mandatory component if such a model has to give rise to a dynamically evolving and increasingly secure system with collective responsibility. Again, in a case wherein similar violations occur repeatedly, the value of CPⱼ(t) might also increase. Otherwise, if the frequency of similar violations decreases over time, the value of CPⱼ(t) might also decrease.

Table#1:CELL[2,2]: This cell captures the scenario where no violation has actually occurred and it has not been reported. The symbol # denotes an undefined value.

Table#1:CELL[3,1]: The 1^{st} cell in the 3^{rd} row represents the scenario where the person Sᵢ supposedly detects a violation but does not report it. Again, for the effectiveness of any community based monitoring, it is necessary that such non-reporting itself is treated as a violation. It is termed a secondary violation to distinguish it from the primary violation of access restrictions on the secure objects.

Such a claim would be valid only when there exists some other person Sⱼ, who also detects/witnesses the same violation and also detects that it has been witnessed by person Sᵢ and person Sⱼ reports it. Note that such a person Sⱼ can also be a neutral monitoring device by which such a claim can be derived as well as verified.

Therefore, the cell Table#1:CELL[3,1] should be considered for person Sᵢ in conjunction with the cell Table#2:CELL[1,1] for some other person Sⱼ as discussed later.

The term −P′ᵢⱼ(t) denotes the price person Sᵢ needs to pay for such non reporting of a violation. In an embodiment, repeated occurrences of such non-reporting by a person invites even harsher punishments, that is, P′ᵢⱼ(t)=c.P′ᵢⱼ(t−1), where c is some constant greater than one.

The difficult part in such a scenario is to validate the correctness of the claim reported by person Sⱼ that person Sᵢ witnessed the primary violation. In general it would require environment specific proofs (e.g., audio-video recordings), but the difficulty of proving such should not exclude such a scenario from consideration.

Table#1:CELL[3,2]: This cell is meant to complete the table which captures an inherently false scenario where person Sᵢ does not report a false primary violation (which of course cannot be detected by anyone else). It is also associated with the undefined value #.

Table#1:CELL[4,1]: The 1^{st} cell in the 4^{th} row represents the scenario complimenting the scenarios considered in the earlier rows. Here person Sᵢ proactively reports a potential violation and is therefore rewarded with θᵢⱼ(t). A collaborative monitoring process can be made more effective if persons proactively point out potential sources of violations based upon their past experiences or analysis of security vulnerability under the existing security policy specifications.

Since a potential violation cannot be observed, it is assumed that it is logically possible to verify its truth for example by generating some hypothetical scenario where such violation would become possible. Examples include: for a newly created logical object, its owner subject/user might report potential access violations with the existing assess enforcement policies. Such reports may facilitate revision of security policy specifications in terms of access restrictions.

Table#1:CELL[4,2]: The 2^{nd} cell in the 4^{th} row represents the scenario where person Sᵢ reports a false potential violation. Similar to above, falsity of such a violation can be logically derived. The symbol # is associated with the value for the corresponding cell since it might not possible to prove that person Sᵢ reported such false potential violation only with malicious intentions and incomplete information. Rather, a faulty analysis can just as well be the basis for the reporting of the false violation.

Table#2: Secondary Violations.

Table#2:CELL[1,1]: The first cell in the table represents the scenario where person Sᵢ detects a violation and also detects that some other person(s) detecting the same violation but do not report it. It is called a secondary violation to distinguish it from the primary violation of access restrictions on secure objects.

This cell event can be true only if for the same person, event corresponding to Table#1:CELL[1,1] is also true: it is a consistency check which states that a secondary violation can be detected (and reported) only in conjunction with a primary violation, and not in isolation. There need also to be some reward associated with this as represented by rᵢⱼ(t).

Table#2:CELL[1,2]: The second cell in the first row represents the scenario where person Sᵢ reports a false secondary violation to falsely implicate other users that they witnessed some violation but did not report it, so there needs to be a punishment with −pᵢⱼ(t).

A false secondary violation cannot be considered in isolation and should be considered in conjunction with some true primary violation, or in conjunction with a false primary violation. Therefore, this cell event is considered only if for the same person, an event corresponding to Table#1:CELL[1,1] or Table#1:CELL[1,2] is also true: that is, it is a consistency check.

Table#2:CELL[2,1]: The 1^{st} cell in the 2^{nd} row represents the scenario where a secondary violation occurs but it is not reported by any person. Since it appears that in general a secondary violation would not have serious negative impact on the whole community, it is given a 0 as a value in this cell.

Table#2:CELL[2,2]: This cell captures the scenario where no secondary violation has actually occurred and it has not been reported as well.

Table#2:CELL[3,1]: The 1^{st} cell in the 3^{rd} row represents the scenario where person Sᵢ supposedly detects a secondary violation but does not report it. Again, for the effectiveness of any community based monitoring, it is necessary that such non-reporting itself be treated as a violation.

This is the case where it is clear from the context of the primary violation that with all possibilities more than two persons must have detected (including Sᵢ) such a violation but none of them reported it.

This must be distinguished from the situation discussed in Table#1:CELL[2,1], where a primary violation occurs but is not reported. This crucial difference is that there might exist certain situations, where primary violation would be by nature undetectable (e.g., littering in a public place at midnight with complete darkness), whereas there might exist scenarios where primary violation must have been witnessed by someone but was never reported (e.g., murder in a broad day light in a market area).

In such a case, each person again pays a community price for such complicity as denoted by −cpⱼ(t).

It is not required that some third person detects and reports such non-reporting of a secondary violation since it can be assumed that it might not be possible in practice to continue to such an extent and such consideration might indeed lead to an indefinite regression.

Again such provisions in the model would give rise to a dynamically evolving and increasingly secure system.

Table#2:CELL[3,2]: this cell is meant to complete the table which captures an inherently false scenario where person Sᵢ does not report a false secondary violation.

Table#2:CELL[4,1]: The 1^{st} cell in 4^{th} row represents the scenario where person Sᵢ reports a potential detection of a violation and also that some other person(s) detecting the same violation but do not report it. This basically means that Sᵢ would be characterizing the potential behavior of certain other persons who have greater probability of witnessing some violation. Consider, for example, security policy specifying that personal calls from a telephone are not allowed, though access to it is not restricted. Based upon past experiences, Sᵢ might report that some person S_{f} might make personal calls, and he or she might do so in collusion with another person (friend) Sₕ, who would watch for the fact that while S_{f} makes the calls, no one else should detect it, and Sₕ himself would not report it. Some reward πᵢⱼ(t) is associated with this type of secondary violation.

Table#2:CELL[4,2]: The 2^{nd} cell in the 4^{th} row represents the scenario where person Sᵢ reports a potential false secondary violation. Such scenarios do not appear to have any serious relevance, hence the symbol # is associated with it.

Assuming there are no external factors undermining the reporting behavior of individuals, using the payoff matrix model, at any point, individual gains from reporting true primary violations are always positive. This statement is supported by the following observation on the payoff matrix design. Suppose a person detects a primary violation. He would be faced with two choices—either he would proceed ahead and report the violation or he would not. In case of the former choice, he becomes entitled to receive the reward, which is a non negative value. However, if he decides to remain silent on the violation, he is taking a risk of loosing some value as a part of community price (provided no one else reports it either), and also the risk of being punished for secondary violations in case there exist some other person who detected the violation and also detected that this person too had witnessed the same and the second person reports both of these violations.

In the case where there are no external factors (e.g., personal relationships with the violators, counter offers by the violator, etc), which counter these payoff matrix based rewards and punishments and motivate a person to remain silent on the violation, he would always be better off by reporting the violations detected. Thus, the model design may be referred to as a safe design.

In one embodiment, subjects can either be actual users or can be software processes executing on behalf of the users, or combinations thereof. With the software processes as subjects with more than one process sharing certain logical objects, each process may be coupled with some monitoring component, which monitors the state of these shared objects on periodic basis or in synchronization with the base process. Alternately, a new design framework may allow designing of processes having normal execution together with monitoring, violation detection, and reporting capabilities.

In one embodiment, the reward-punishment based framework for collaboratively monitoring the assets in an organization can be seamlessly integrated with any existing security infrastructure in place with minimal additions. The following elements may be used to implement various aspects of such a framework:
i) A network centric data collection mechanism, which can be used by the users to report violations and other relevant information (criticality level etc)
ii) Background support for simple arithmetic calculations to update payoff matrices
iii) Support for determining truth and falsity of the reported violations
iv) Support for determining and realizing payoffs, and
v) A mechanism to publish relevant information to generate awareness among users.

In case of users as actual subjects, implementation of the collaborative monitoring model demands suitable framework of disseminating the information on the proposed pay-off matrices to all the users as well as mechanisms for reporting the detection of primary or secondary violations. Associated rewards as well as punishments may be decided in a time varying manner to render the system adaptive together with adequate confidentiality measures for protecting the identities of the reporting users.

The parameters defining the rewards and punishments in the pay-off matrix may be determined based upon the characteristics of the objects and the subjects accessing the objects at any point in time. For example, with mandatory access control based security frameworks, employed for highly confidential assets (e.g., in military establishments), objects are differentiated according to their sensitivity levels, and the subjects are categorized based on their clearance levels. Usually user accesses are limited according to their clearance levels. There may be a number of schemes for defining the rewards and punishment criteria in terms of these levels. A simple scheme may be where a reward implies the increase in the clearance level of a particular user, and punishment results into decrease in his clearance level.

In reporting a violation, time is an important parameter. In general, the potential loss owing to a violation increases with an increase in the delay of reporting the violation. So, reporting time may also play a role in deciding the reward for reporting a violation. In one embodiment, time reporting is defined as the time difference between violation of a policy, and reporting of such violation. λ(s) denotes the clearance level of subject s, and λ(o) denotes the sensitivity level of an object o. The reward for reporting a violation of an access restriction on object o by subject s can be defined as follows:

λ(s)=λ(s)+f(λ(o), rₜ)

where f(λ(o), rₜ) is any monotonically non-decreasing function of the sensitivity of object o, and rₜ, which denotes the reporting time. The value returned by the function increases with the increase in the value of λ(o), and decreases with the increase in the value of rₜ.

As a concrete example, if it is considered that there are N different levels for determining clearance and sensitivity levels, reward may be defined as:

λ(s)=[λ(s)]+[λ(o)/N]+[1−rₜ/R]

where R denotes the maximum delay possible before the violation would get detected.

A reward can alternately be defined in terms of reduction in loss owing to the timely reporting the violation. For example,

Reward(s, o)=α(MaxLoss−ActualLoss)

where MaxLoss is the maximum possible loss, which could have happened if no user reported the violation, and ActualLoss is the actual loss after it was reported. α is some constant in the interval [0,1].

Other parameters for rewards and punishments may also be defined accordingly for any given system set up. Other parameters in the pay-off matrices can also be defined similarly. In general, deciding appropriate rewards and punishments may be dependent on the nature of the policy violations, their impact on the organization, ease of detecting them by the community members, and the nature of the groups associated with monitoring the policy violations. Nonetheless, some generic points may be extracted from the studies on extrinsic motivation.

Reward induced behaviors in individuals tend to stop once the rewards are withdrawn. This may be referred to as an over justification effect. This fact places important constraints on deciding the rewards. For example, it implies that rewards must not be withdrawn suddenly, but gradually. Also, individuals evaluate the value of the rewards, which in turn determines their motivations for the tasks underlying the rewards, as compared to their current conditions (socio-economic status, responsibilities, etc). Hence rewards catering to the satisfaction level of the individuals may be more effective. However, there are studies resulting in a Minimal Justification Principle, which implies that an organization should give people small rewards for the things they should keep doing.

In some embodiments, a community price works as a negative reinforcement mechanism on the group level. Hence it would motivate people to monitor violations to avoid paying such price. Therefore, for it to be effective, community prices may be enforced strictly in the beginning though they should always be reduced as soon as reporting behavior has been adequately reinforced within the community. Similarly, punishments for false reporting and secondary violations work as negative enforcements for the individuals and hence may be strictly followed in the beginning and should not cease at any point of time so that individuals do not revert back to wrong behavior.

A safety property is a security property, which may be used to evaluate the effectiveness of the model. The general meaning of safety in the context of protection is that no access rights can be leaked to an unauthorized subject, i.e. given some initial safe state, there is no sequence of operations on the objects/resources, that would result in an unsafe state. Safety, in general, is only decidable in very restricted cases. Unlike the usual security models, the model is actually a monitoring model, and robustness properties are more relevant to the model.

A monitoring policy is called probabilistically strongly robust if over a course of time the rate of access to restriction violations steadily decreases. A monitoring policy is called probabilistically weakly robust if over a course of time the rate of detections and reporting of true violations reaches the rate of actual violations and the rate of false violations decrease.

Formally, let rᵥᵢₒ(t) correspond to the number of violations per unit time distributed over time, e.g., distribution on the number of violations per year. A similar rate of reporting, say rᵣₑₚ(t), is a distribution of the number of cases reported for true violations per unit time. Let r_{false}_{_{—}}ₚᵣᵢ(t) and r_{false}_{_{—}}_{sec}(t) denote the rate of distributions for false primary and secondary violations respectively. Then, a probability distribution for the occurrence as well as reporting of a true violation can be approximated as (rᵣₑₚ(t)/rᵥᵢₒ(t)).

Thus for a probabilistically strong robust monitoring:

Lim_{t→∞}rᵥᵢₒ(t)=0

Whereas for a probabilistically weakly robust monitoring model

Lim_{t→∞}(rᵣₑₚ(t)/rᵥᵢₒ(t))=1 and

Lim_{t→∞}r_{false}_{_{—}}ₚᵣᵢ(t)=0 and

Lim_{t→∞}r_{false}_{_{—}}_{sec}(t)=0

The current disclosure relates to a formal model which can be used by security administrators to get better estimates on various factors affecting the required parameters controlling the payoff values, e.g., reporting behavior of users, group dynamics, characteristics of the violations, and likelihood of detection. The proposed model effectively complements the payoff matrix-based approach for enabling the collaborative monitoring of policy violations.

The proposed model effectively complements the payoff matrix based approach for enabling the collaborative monitoring of policy violations. Through probabilistic model checking, the degrees of success of the monitoring mechanism are estimated in different settings. Towards this goal, a Probabilistic Computation Tree Logic (PCTL) property is specified to measure the probability of a violation (primary or secondary) to be reported by at least one subject. As is known in the art, the PCTL language can specify desired system behavior—where the system is represented by a discrete Markov chain. PCTL can express untimed properties via the expected probability with which the system should satisfy some desired goals (e.g., deadlines) during its operation. A PCTL property can be checked against all possible ways a system can operate. In this particular instance, the probability of a violation (primary or secondary) denotes the degree of success of the monitoring mechanism in a particular setting. Examples can be carried out to gain an insight of what should be the values of different components of a payoff matrix to achieve a particular degree of success.

The dynamics of collaborative monitoring depends on various factors. First of all, not all policy violations are equally likely to be detected. Moreover, if a user detects a violation, whether he would actually report the violation or not depends on different issues, for example, the rewards he would get for reporting the violation, the punishment that he might receive if he does not report the violation, and any hidden incentives associated with not reporting the violation. The behavior of the system is modeled as a probabilistic system, and more precisely, as a Markov Decision Process (MDP) that demonstrates how a model checking-based approach can help an administrator determine different parameters in the payoff matrix.

In an embodiment, the model is provided with a set of subjects

S={s₁,s₂, . . . , sₙ}

and a set of violations

Vio={vio₁, vio₂, . . . , vioₘ}

Further, p_{detj} is the probability that a violation vioⱼ could be detected by any subject, which indicates the inherent difficulty in detecting the violation. Similarly p_{det}_{_{—}}_{secij} denotes the probability that subject sᵢ detects a secondary violation by any other subject on violation vioᵢⱼ. The probability Pᵣₑₚᵢⱼ denotes that the subject sᵢ ε S will report a primary violation vioⱼ. Similarly the probability pᵣₑₚ_{_{—}}_{secij} denotes that the subject sᵢ, will report a secondary violation on vioⱼ.

Payoff matrices for primary and secondary violations for each of the subjects against each policy violation can be represented as follows:

[symbol]

( P̅T̅₁̅,̅S̅T̅₁̅) . . . ( P̅T̅ₙ̅,̅S̅T̅ₙ̅)

[symbol]

where each person sᵢ is associated with primary payoff tables [( P̅T̅ᵢ̅)]=[T^{P}ᵢ₁,T^{P}ᵢ₂, . . . T^{P}ᵢₘ] and secondary payoff tables [( S̅T̅ᵢ̅)]=[T^{S}ᵢ₁,T^{S}ᵢ₂, . . . T^{S}ᵢₘ] such that T^{P}ᵢⱼ,T^{S}ᵢⱼ denote the payoff tables corresponding to policy violation vioⱼ.

A motivation index, mᵢⱼ, is defined for a subject sᵢ to report a violation vioⱼ. The motivation index is a measure of the motivation a subject has for reporting a violation. The motivation index can be considered to be determined by the following factors:
1. Individual gain from the reward.
2. Fear of community price and punishment for a secondary violation.
3. A number of factors that collectively can act as a deterrent for reporting the violation.

In general, quantitative measures for these factors are situational, however, the following measure may be considered for defining mᵢⱼ:

mᵢⱼ=|T^{P}ᵢⱼ[1,1]|+|T^{P}ᵢⱼ[2,1]|+|T^{P}ᵢⱼ[3,1]|−Ωⱼ

where T^{P}ᵢⱼ[1,1] is the reward that sᵢ would gain for reporting a true violation vioⱼ, T^{P}ᵢⱼ[2,1] is the corresponding community price if none of the subjects detecting the violation report it, and T^{P}ᵢⱼ[3,1] is the punishment for the secondary violation, that is, the loss that sᵢ would have in case he does not report the violation but in turn some other subject reports against him for not reporting the violation. The term Ωⱼ indicates the effect of the factors that collectively can act as a deterrent for reporting the violation. For simplicity, it is defined as a fraction δ ε [0,1] of the MaxLossⱼ, which is the maximum loss caused by the violation.

Ωⱼ=δ*MaxLossⱼ

In this definition, it can be assumed that the factors which would work against reporting a violation could be indirectly related with the “share” in the gain sᵢ that one may have by not reporting the violation. In an embodiment, it is assumed that the probability of reporting a violation by sᵢ is approximately related to mᵢⱼ as follows:

$$\begin{matrix}{p}_{{rep}_{ji}} = 1 - \frac{1}{1 + {m}_{ij}} for {m}_{ij} > 0 \\ = 0 for {m}_{ij} <= 0\end{matrix}$$

The above system model is designed as an MDP and properties are expressed in terms of PCTL. A property expressed in PCTL captures the probability of a violation to be reported by at least one subject. The probabilistic model checker PRISM is then used for modeling and analysis of the MDP model. PRISM is a tool for formal modeling and analysis of systems which exhibit probabilistic behavior including MDPs, and provides support for automated analysis of a wide range of quantitative properties of these models. The PRISM model is discussed next.

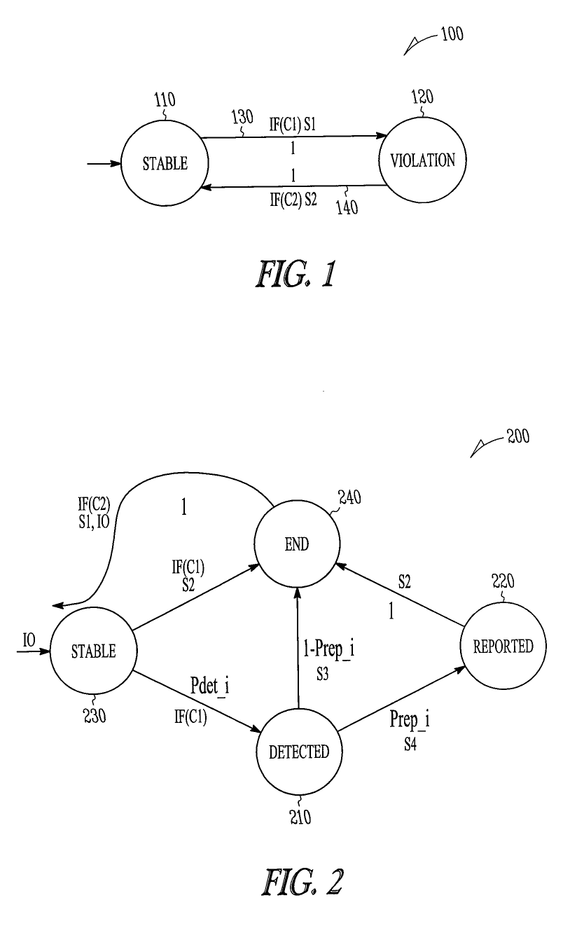

The occurrence of a violation is captured in an environment module in the Prism model. The violations are assumed to be occurring independent of each other. Therefore, only one violation is considered and the consequences related to it studied. States of the environment module are denoted by a state_env variable and the states of subject sᵢ are represented using a state—subi. A violation may occur only when the system is in a stable state, i.e., the environment module as well as all the subjects are in their stable states. When all the subjects complete their reporting activities related to the violation, the system again returns to the stable state. The model of environment is shown in FIG. 1. Specifically, FIG. 1 illustrates a diagram 100 showing subjects in their stable states 110 and violations 120. Transitions between the stable states 110 and the violations 120 are indicated at 130 and 140.

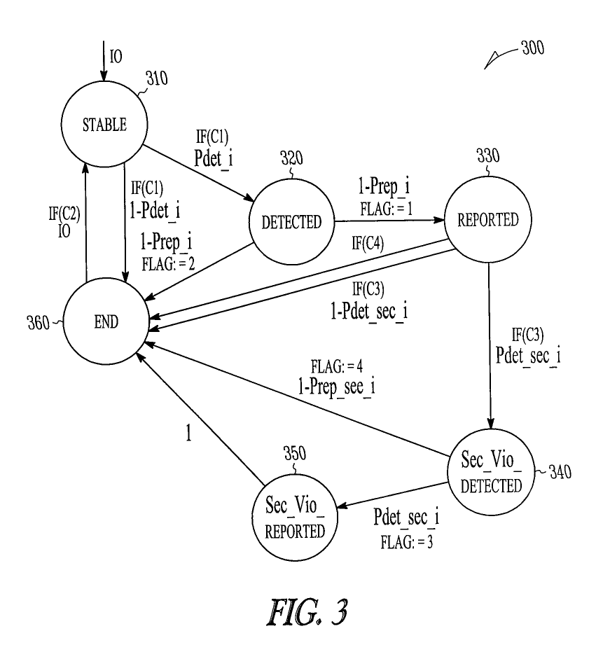

FIG. 2 illustrates a transition diagram 200 for a subject. A subject stays in a stable state 230 when no violation occurs. When a violation occurs, a subject may or may not detect the violation at 210 based on a detection probability. Therefore, from the stable state, the subject can go to a detected state with probability p_{det} and to an end state 240 with probability 1−P_{det}. If the subject is in the detected state 210, it can either report the violation with its reporting probability pᵣₑₚ and transit this to a reported state 220, or it may not report the violation with probability 1−pᵣₑₚ and in turn may transit to the end state 240. After reporting the violation the subject moves to the end state 240. When all subjects are in their end states 240 and there is no more activities from the subjects regarding the violations, the environment module can then move to its stable state 230. When the environment is in the stable state 230 after a violation, all the subjects also move to their stable states 230.

A flag is used to distinguish two different possible behaviors of a subject after detecting a violation. In the stable state 230, the flag is set to 0. If a subject reports the violation, its flag is set to 1 on transitioning to the reported state 220. Otherwise, if the subject does not report the violation after detecting it, its flag is set to 2. When the subject moves from the end state 240 to the stable state 230, the flag is set to 0. This flag is used in writing PCTL properties and for modeling secondary violations, as is disclosed hereinafter.

As illustrated in FIG. 3, the module 320 for a subject reporting only the primary violations at 330 can be extended at 340 to capture the activity of the subject related to secondary violations (which can be reported at 350). The primary condition of detecting at 340 and reporting at 350 a secondary violation is that the subject has to report the corresponding primary violation at 330 also. So in the model of a subject for primary violation, if the subject is in the reported state 330, the subject may detect a secondary violation at 340 by the other subject. From the reported state 330, the subject may detect a secondary violation at 340 with probability P_{detsec} and may move to sec-vio-detected state 340 with probability P_{det}_{_{—}}_{sec} and the end state 360 with probability 1−_{pdet}_{_{—}}_{sec}. From sec-vio-detected state 340, the subject may move to sec₁₃ vio_reported 350 with probability Pᵣₑₚ_{_{—}}_{sec} or may move to the end state 360 with probability 1−Pᵣₑₚ_{_{—}}_{sec}. If a subject reports a secondary violation after detecting it, its flag is set to 3, otherwise the flag is set to 4. In FIG. 3, flagᵢ denotes the flag for the subject being considered by the model and flagⱼ corresponds to the other subject.

The combined system can be represented as

Sys: {θ}[Env ∥ Sub₁∥ . . . ∥Subₙ]

Where Env denotes the environment module used for generating violations, Sub₁ . . . Subₙ model the behavior of the subjects s₁, s₂, . . . , sₙ, and θ specifies the initial values of variables. The symbol “∥” is used to indicate asynchronous (concurrent) composition of the components.

In order to find out the desired probabilities, the properties in PCTL are specified. For a primary violation, the probability of a violation to be reported by at least one subject is of interest. As the model is specified as an MDP, the minimum probability of satisfying the requirement is computed. The following PCTL property is specified:

Pmin=? [“q1”=>true U(“q2” & “q3”)]

where, q1≡s=1, q2≡(f1=1)|(f2=1)| . . . |(fn=1) and q3≡s=0. The term s denotes the state of environment, and s=0 denotes that the environment is in the stable state and s=1 denotes that the environment is in a violated state. The terms f1, f2, . . . , fn denote the flag associated with different subjects. When the value of a flag is 1, the corresponding subject has reported a violation.

The probability of reporting a secondary violation by a subject can be calculated by specifying a similar property. The following property finds out the probability of reporting a secondary violation by subject 1:

Pmin=? [“q4”=>true U(“q5” & “q3”)]

where q4=≡f2=2 and q5=f1=4. The term f2-2 denotes that subject 2 has detected, but not reported, the primary violation, and thus committed a secondary violation. The term f1=4 denotes that subject 1 has reported the secondary violation.

An example evaluation was carried out in order to understand how different parameters such as detection probability, motivation index, and number of subjects contribute to reporting probability of a violation. In this example, one of the three parameters was fixed, and the other two parameters were varied to see the effect of the changes in those two parameters on the reporting probability.

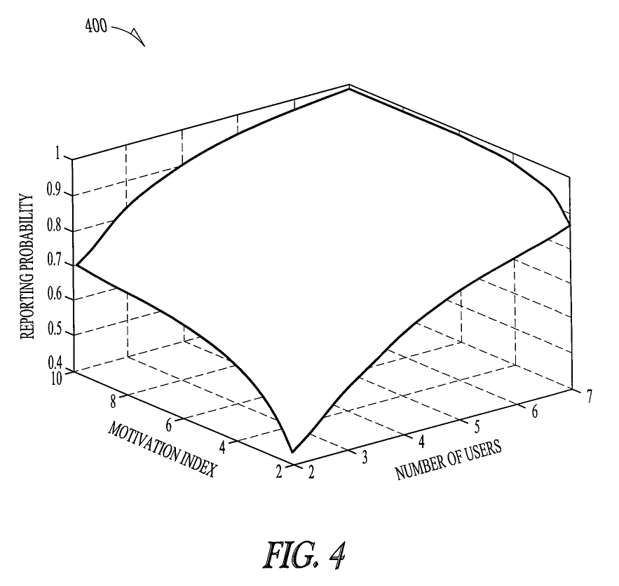

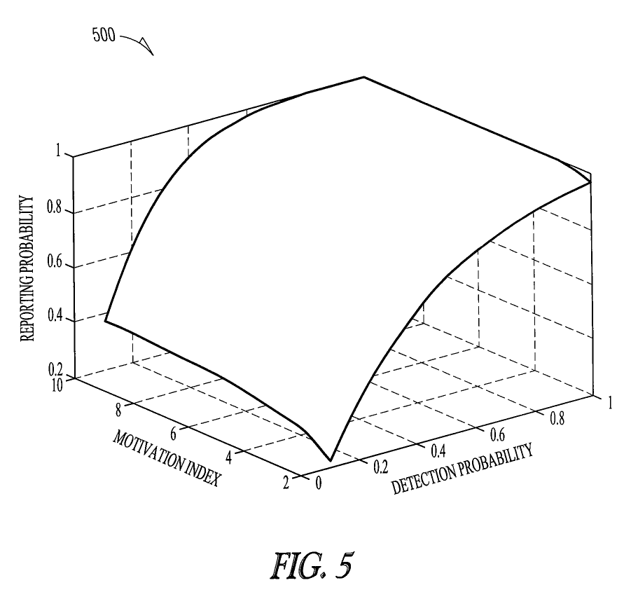

FIG. 4 is a graph 400 that illustrates the variation of reporting probability with changes in the number of subjects and motivation index for a detection probability=0.5. An administrator can get useful insight from this kind of example. If an administrator can determine the detection probability for a policy violation from his or her experience, and if the number of associated subjects is also known, the required value of the motivation index can be assessed to achieve a particular reporting probability for the violation. This knowledge would in turn be used to determine the values for different entries in the payoff matrix for a subject-violation pair corresponding to the evaluated motivation index and associated reporting probability.

FIG. 5 is a graph 500 that illustrates the variation of reporting probability with changes in the detection probability and the motivation index for a number of users equal to 5. This is useful in the scenarios where a group of subjects are associated with an asset for which different violations are possible, and detection probabilities for these violations are also different. FIG. 5 will give an administrator useful information about the motivation index for different violations for the same group of subjects.

While deploying the collaborative monitoring system, an administrator has to determine the detection probability of a subject for a violation from his expression or intuition. This approach may be very subjective, and sometimes far away from the correct values. However to deploy the collaborative monitoring system, it is required to start with some values for detection probability. However, with some enhancement in the collaborative monitoring system, it is possible to have a good estimate of detection probability of a user for some violation. The collaborative monitoring system should be capable of keeping track of the total number of violations, the number of primary violations reported by a subject, and number of secondary violations reported against the subject in a period of time. From this data, it is possible to calculate the approximate value of the detection probability of the subject for that violation. More specifically, the actual detection probability will always be greater than the calculated one.

For example, assume that the time period which is considered for calculating the detection probability of subject sᵢ for violation vⱼ is d days. In these d days, the number of primary violations reported against violation vⱼ is N. Also, the number of primary violations reported by subject s is nₚ, and the number of secondary violations reported against subject sᵢ is nₛ. So, if the actual detection probability of subject sᵢ for violation vⱼ is p_{det}_{_{—}}_{actual}, then

$${p}_{{det\_actual}_{y}} \geq \frac{{n}_{p} + {n}_{s}}{N}$$

The administrator now has a new estimate for the detection probability of a subject for a violation. This new detection probability of subject sᵢ for violation vⱼ can be denoted as follows:

$${p}_{{det\_new}_{y}} \geq \frac{{n}_{p} + {n}_{s}}{N}$$

The administrator should run the experiment again to get an estimate of a new reporting probability, or to estimate a new motivation index for achieving the previous reporting probability. Note that the detection probabilities now may be different for different subjects. Though as disclosed above, the same detection probability has been considered for all the subjects. The model can be enhanced for different detection probabilities for different subjects since the models for individual subjects are independent from each other.

FIG. 8 is a flowchart of an example process 800 for prioritizing threats or violations in a security system. FIG. 8 includes a number of process blocks 805-865. Though arranged serially in the example of FIG. 8, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring to FIG. 8, at 805, a process to monitor dynamic behavior of a collaborative monitoring system includes providing a payoff matrix. At 810, the process includes performing a probabilistic model check on the payoff matrix, and at 815, the process includes using a probability from the probabilistic model check to determine a degree of success of the monitoring. At 820, the probabilistic model check measures a probability of a primary or secondary violation. At 825, the payoff matrix comprises values relating to one or more of reporting a behavior of users, a group dynamic, a characteristic of the violations, and a likelihood of detection. At 830, values in the payoff matrix are determined by a Markov Decision Process. At 835, the process 800 includes providing a primary violation payoff matrix and a secondary violation payoff matrix for a person, and at 840, the process 800 includes determining a motivation index for the person to report a violation. At 845, the motivation index is related to one or more of an individual gain from a reward, a community price and punishment for a secondary violation, and a factor relating to a deterrent for reporting a violation. At 850, the process 800 includes defining the motivation index by providing a reward for a person reporting a true violation. At 855, the process 800 includes capturing a violation in an environment module, and at 860, the process 800 includes recording a reporting or a non-reporting of a violation by a person in a subject module. At 865, the process 800 includes analyzing a reporting probability as a function of a number of subjects and a motivation index.

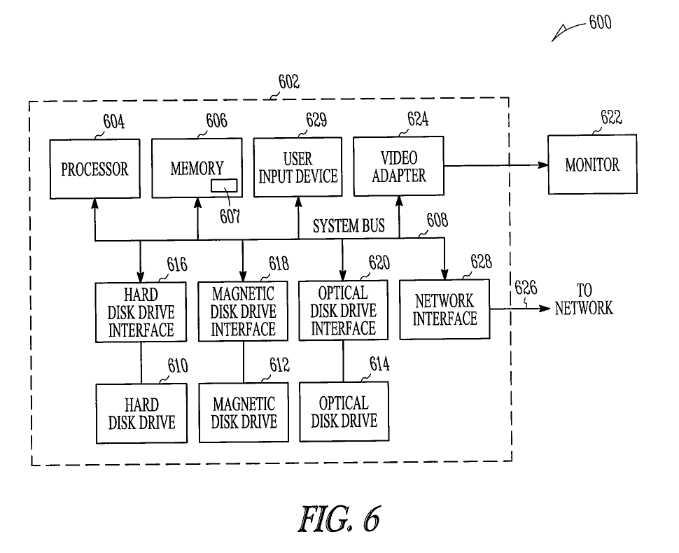

FIG. 6 illustrates a block diagram of a data-processing apparatus 600, which can be adapted for use in implementing a preferred embodiment. It can be appreciated that data-processing apparatus 600 represents merely one example of a device or system that can be utilized to implement the methods and systems described herein. Other types of data-processing systems can also be utilized to implement the present invention. Data-processing apparatus 600 can be configured to include a general purpose computing device 602. The computing device 602 generally includes a processing unit 604, a memory 606, and a system bus 608 that operatively couples the various system components to the processing unit 604. One or more processing units 604 operate as either a single central processing unit (CPU) or a parallel processing environment. A user input device 629 such as a mouse and/or keyboard can also be connected to system bus 608.

The data-processing apparatus 600 further includes one or more data storage devices for storing and reading program and other data. Examples of such data storage devices include a hard disk drive 610 for reading from and writing to a hard disk (not shown), a magnetic disk drive 612 for reading from or writing to a removable magnetic disk (not shown), and an optical disk drive 614 for reading from or writing to a removable optical disc (not shown), such as a CD-ROM or other optical medium. A monitor 622 is connected to the system bus 608 through an adaptor 624 or other interface. Additionally, the data-processing apparatus 600 can include other peripheral output devices (not shown), such as speakers and printers.

The hard disk drive 610, magnetic disk drive 612, and optical disk drive 614 are connected to the system bus 608 by a hard disk drive interface 616, a magnetic disk drive interface 618, and an optical disc drive interface 620, respectively. These drives and their associated computer-readable media provide nonvolatile storage of computer-readable instructions, data structures, program modules, and other data for use by the data-processing apparatus 600. Note that such computer-readable instructions, data structures, program modules, and other data can be implemented as a module 607. Module 607 can be utilized to implement the methods depicted and described herein. Module 607 and data-processing apparatus 600 can therefore be utilized in combination with one another to perform a variety of instructional steps, operations and methods, such as the methods described in greater detail herein.

Note that the embodiments disclosed herein can be implemented in the context of a host operating system and one or more module(s) 607. In the computer programming arts, a software module can be typically implemented as a collection of routines and/or data structures that perform particular tasks or implement a particular abstract data type.

Software modules generally comprise instruction media storable within a memory location of a data-processing apparatus and are typically composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. The term module, as utilized herein can therefore refer to software modules or implementations thereof. Such modules can be utilized separately or together to form a program product that can be implemented through signal-bearing media, including transmission media and recordable media.

It is important to note that, although the embodiments are described in the context of a fully functional data-processing apparatus such as data-processing apparatus 600, those skilled in the art will appreciate that the mechanisms of the present invention are capable of being distributed as a program product in a variety of forms, and that the present invention applies equally regardless of the particular type of signal-bearing media utilized to actually carry out the distribution. Examples of signal bearing media include, but are not limited to, recordable-type media such as floppy disks or CD ROMs and transmission-type media such as analogue or digital communications links.

Any type of computer-readable media that can store data that is accessible by a computer, such as magnetic cassettes, flash memory cards, digital versatile discs (DVDs), Bernoulli cartridges, random access memories (RAMS), and read only memories (ROMs) can be used in connection with the embodiments.

A number of program modules, such as, for example, module 607, can be stored or encoded in a machine readable medium such as the hard disk drive 610, the, magnetic disk drive 612, the optical disc drive 614, ROM, RAM, etc. or an electrical signal such as an electronic data stream received through a communications channel. These program modules can include an operating system, one or more application programs, other program modules, and program data.

The data-processing apparatus 600 can operate in a networked environment using logical connections to one or more remote computers (not shown). These logical connections can be implemented using a communication device coupled to or integral with the data-processing apparatus 600. The data sequence to be analyzed can reside on a remote computer in the networked environment. The remote computer can be another computer, a server, a router, a network PC, a client, or a peer device or other common network node. FIG. 6 depicts the logical connection as a network connection 626 interfacing with the data-processing apparatus 600 through a network interface 628. Such networking environments are commonplace in office networks, enterprise-wide computer networks, intranets, and the Internet, which are all types of networks. It will be appreciated by those skilled in the art that the network connections shown are provided by way of example and that other means and communications devices for establishing a communications link between the computers can be used.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate example embodiment.

1. A process to monitor dynamic behavior of a collaborative monitoring system comprising:
providing a payoff matrix;
performing a probabilistic model check on the payoff matrix; and
using a probability from the probabilistic model check to determine a degree of success of the monitoring.

2. The process of claim 1, wherein the probabilistic model check measures a probability of reporting a primary or secondary violation.

3. The process of claim 1, wherein the payoff matrix comprises values relating to one or more of reporting a behavior of users, a group dynamic, a characteristic of the violations, and a likelihood of detection.

4. The process of claim 1, wherein values in the payoff matrix are determined by representing the system components by a Markov Decision Process and verifying suitable Probabilistic Computation Tree Logic (PCTL) properties on processes in the system.

5. The process of claim 1, comprising:
providing a primary violation payoff matrix and a secondary violation payoff matrix for a person; and
determining a motivation index for the person to report a violation.

6. The process according to claim 5, wherein the motivation index is related to one or more of an individual gain from a reward, a community price and punishment for a secondary violation, and a factor relating to a deterrent for reporting a violation.

7. The process according to claim 5, comprising defining the motivation index by providing a reward for a person reporting a true violation.

8. The process of claim 1, comprising:
capturing a violation in an environment module; and
recording a reporting or a non-reporting of a violation by a person in a subject module.

9. The process of claim 1, comprising analyzing a reporting probability as a function of a number of subjects, a motivation index, and a detection probability of a violation.

10. A system comprising one or more processors configured to monitor dynamic behavior of a collaborative monitoring system by:
providing a payoff matrix;
performing a probabilistic model check on the payoff matrix; and
using a probability from the probabilistic model check to determine a degree of success of the monitoring.

11. The system of claim 10, wherein the probabilistic model check measures a probability of reporting a primary or secondary violation.

12. The system of claim 10, wherein values in the payoff matrix are determined by representing the system components by a Markov Decision Process and verifying suitable Probabilistic Computation Tree Logic (PCTL) properties on processes in the system.

13. The system of claim 10, wherein the one or more processors are configured to:
provide a primary violation payoff matrix and a secondary violation payoff matrix for a person; and
determine a motivation index for the person to report a violation.

14. The system of claim 13, wherein the one or more processors are configured to define the motivation index by providing a reward for a person reporting a true violation.

15. The system of claim 10, wherein the one or more processors are configured to:
capture a violation in an environment module; and
record a reporting or a non-reporting of a violation by a person in a subject module.

16. A computer readable medium comprising instructions that when executed by a processor perform a process to monitor dynamic behavior of a collaborative monitoring system comprising:
providing a payoff matrix;
performing a probabilistic model check on the payoff matrix; and
using a probability from the probabilistic model check to determine a degree of success of the monitoring.

17. The machine readable medium of claim 16, wherein the probabilistic model check measures a probability of reporting a primary or secondary violation.

18. The machine readable medium of claim 16, wherein values in the payoff matrix are determined by representing the system components by a Markov Decision Process and verifying suitable Probabilistic Computation Tree Logic (PCTL) properties on processes in the system.

19. The machine readable medium of claim 16, comprising instructions for:
providing a primary violation payoff matrix and a secondary violation payoff matrix for a person;
determining a motivation index for the person to report a violation; and
defining the motivation index by providing a reward for a person reporting a true violation.

20. The machine readable medium of claim 16, comprising instructions for:
capturing a violation in an environment module; and
recording a reporting or a non-reporting of a violation by a person in a subject module.
